(19) United States
(12) Patent Application Publication
(10) Pub. No.: US 2003/0043401 A1
(43) Pub. Date: Mar. 6, 2003

(54) System and method for estimating ink usage of a print job

(76) Inventors: Donald R. Abel, Sherwood, OR (US); Jennifer Geske, Vancouver, WA (US); William Hertling, Portland, OR (US)

Correspondence Address: HEWLETT-PACKARD COMPANY, Intellectual Property Administration, P.O. Box 272400, Fort Collins, CO, 80527-2400, US

(21) Appl. No.: 09/943,917

(22) Filed: Aug. 31, 2001

(51) Int. Cl. G06F 3/12; G06F 13/10; G06F 17/00; B41J 2/195; B41J 29/393

(52) U.S. Cl. 358/1.14; 358/1.15; 709/321; 705/400; 710/8; 347/19

(57) ABSTRACT

The present invention includes an embodiment for estimating ink usage of a print job, comprising connecting a computer peripheral device to a host computer having predefined information relating to the peripheral device and offering pricing and estimation of ink and image consumables to complete the print job, before the print job is performed. The present invention also includes an embodiment as an ink usage monitoring system for estimating ink usage of a print job, comprising a computer peripheral device for performing the print job and a host computer connected to the computer peripheral device and having predefined information relating to the peripheral device. The host computer has pricing and estimation of ink and image consumables to complete the print job, before the print job is performed.

### FIELD OF THE INVENTION

One embodiment of the present invention generally relates to image forming devices and in particular to a system and method for estimating ink usage with a stand alone generic printer driver or a remote printer driver associated with a server.

### BACKGROUND OF THE INVENTION

Inkjet printers are becoming common in network environment systems, which may employ a combination of computers and combinations of peripheral devices in Internet workflow subsystems, as well as in systems linked directly through the Internet. One such environment comprises a home environment including a personal computer (PC) and a dedicated computer peripheral device such as a printer that is coupled with the PC via a local (or system) bus. Such an environment has been referred to as a single-connection environment, and is exclusive of a computer network environment, but may include a connection to an external network such as the Internet.

Another environment comprises an unmanaged network environment including a personal computer, an unmanaged network, and a computer peripheral device having an embedded web server. Yet another environment comprises a managed, enterprise network environment including a server, one or more personal computers, and one or more computer peripheral devices. These systems provide lines of communication, and at various points in the systems, they require hard copy output engines.

As computer systems and data communication systems have developed, the number and variety of hard copy output engines employed in network environments has grown. Examples include photocopiers, facsimile machines, printers, and devices incorporating a combination of these peripheral devices. As need for these types of hard copy output engines has grown, a number of different manufacturers have developed different hard copy output engines providing different operational characteristics and capabilities. While some consumable commodities associated with these devices are common to most or all such devices (e.g. standardized paper sizes), other consumable commodities, such as toner supply cartridges or ink reservoirs, tend to be unique to a specific product line from that manufacturer.

Additionally, different hard copy output engines have different paper capacities, capabilities for accepting more or fewer paper sizes and different toner or other pigment supply requirements and capacities. Further, as hard copy output engines have been developed to provide increasing capabilities, the number of different consumable supplies utilized by the hard copy output engines has grown.

In the past, the ordering of consumables for computer peripheral devices within any one or more of the above environments was a manual process. For example, consumables were manually ordered by single connection environment users for photocopiers, facsimile machines, printers and multiple function peripheral devices. More recently, self adjusting consumable order assistance systems have been configured for use in multiple environments including single connection environments, unmanaged network environments, and centralized server based network environments.

However, these systems do not inform the user of the amount of imaging consumables used prior to the job commencing. In addition the user is unable to compare the requirements of producing images on one system with that of another or a plurality of other systems. Therefore, what is needed is a system and method that overcomes these problems.

### SUMMARY OF THE INVENTION

To overcome the limitations in the prior art described above, and to overcome other limitations that will become apparent upon reading and understanding the present specification, the present invention includes an embodiment for estimating ink usage of a print job. This embodiment comprises connecting a computer peripheral device to a host computer having predefined information relating to the peripheral device and offering pricing and estimation of ink and image consumables for completing the print job, before the print job is performed.

The present invention also includes an embodiment as an ink usage monitoring system for estimating ink usage of a print job, comprising a computer peripheral device for performing the print job and a host computer connected to the computer peripheral device and having predefined information relating to the peripheral device. The host computer has pricing and estimation of ink and image consumables for completing the print job, before the print job is performed.

The present invention as well as a more complete understanding thereof will be made apparent from a study of the following detailed description of the invention in connection with the accompanying drawings and appended claims.

### BRIEF DESCRIPTION OF THE DRAWINGS

Embodiments of present invention can be further understood by reference to the following description and attached drawings that illustrate the preferred embodiment. Other features and advantages will be apparent from the following detailed description of the preferred embodiment, taken in conjunction with the accompanying drawings, which illustrate, by way of example, the principles of the invention.

FIG. 1 is an exemplary printer that incorporates one embodiment of the invention and is shown for illustrative purposes only.

FIG. 2 shows a block diagram of a communication system incorporating one embodiment of the present invention.

FIG. 3 illustrates a flowchart depicting how the print job is sent to the host according to one embodiment of the present invention.

### DETAILED DESCRIPTION OF THE PREFERRED EMBODIMENTS

In the following description of the invention, reference is made to the accompanying drawings, which form a part hereof, and in which is shown by way of illustration a specific example in which embodiments of the invention may be practiced. It is to be understood that other embodiments may be utilized and structural changes may be made without departing from the scope of one embodiment of the present invention.

I. Exemplary Printing System

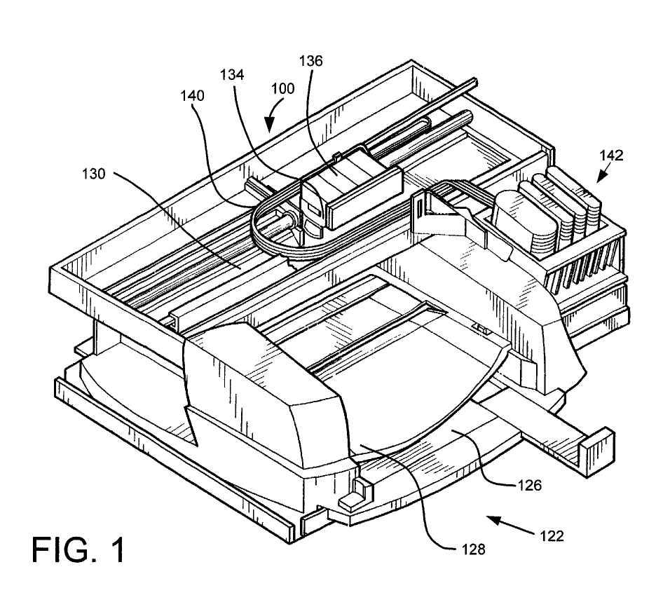

FIG. 1 is an exemplary high-speed printer that incorporates one embodiment of the present invention printing system 100 for estimating ink usage with a stand alone generic printer driver or a remote printer driver associated with a server and is shown for illustrative purposes only. Generally, the printing system 100 includes a tray 122 for holding print media. When a printing operation is initiated, print media, such as paper, is fed into printer 100 from tray 122 preferably using a sheet feeder 126. The sheet then brought around in a U direction and travels in an opposite direction toward output tray 128. Other paper paths, such as a straight paper path, can also be used.

The sheet is stopped in a print zone 130, and a scanning carriage 134, supporting one or more printhead assemblies 136, is then scanned across the sheet for printing a swath of ink thereon. After a single scan or multiple scans, the sheet is then incrementally shifted using, for example, a stepper motor and feed rollers to a next position within the print zone 130. Carriage 134 again scans across the sheet for printing a next swath of ink. The process repeats until the entire sheet has been printed, at which point it is ejected into output tray 128.

One embodiment of the present invention is equally applicable to alternative printing systems (not shown) that utilize alternative media and/or printhead moving mechanisms, such as those incorporating grit wheel, roll feed or drum technology to support and move the print media relative to the printhead assemblies 136. With a grit wheel design, a grit wheel and pinch roller move the media back and forth along one axis while a carriage carrying one or more printhead assemblies scans past the media along an orthogonal axis. With a drum printer design, the media is mounted to a rotating drum that is rotated along one axis while a carriage carrying one or more printhead assemblies scans past the media along an orthogonal axis. In either the drum or grit wheel designs, the scanning is typically not done in a back and forth manner as is the case for the system depicted in FIG. 1.

The print assemblies 136 can be removeably mounted or permanently mounted to the scanning carriage 134. Also, the printhead assemblies 136 can have self-contained ink reservoirs as the ink supply. The self-contained ink reservoirs can be refilled with ink for reusing the print assemblies 136. Alternatively, each print cartridge 136 can be fluidically coupled, via a flexible conduit 140, to one of a plurality of fixed or removable ink containers 142 acting as the ink supply. As a further alternative, the ink supplies can be one or more ink containers separate or separable from printhead assemblies and removeably mountable to carriage 134.

II. General Overview:

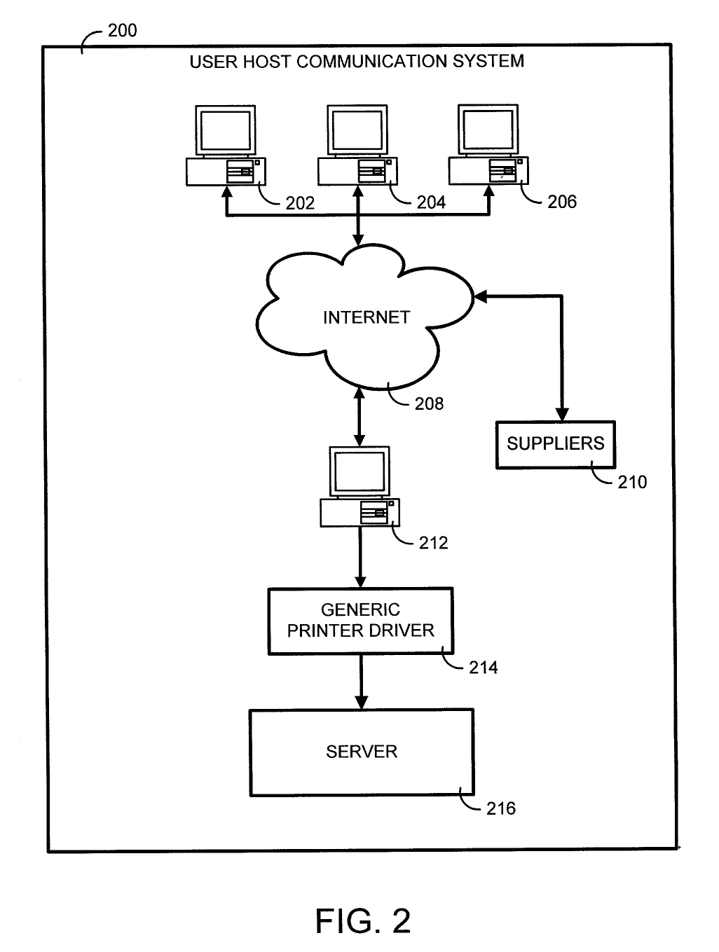

FIG. 2 shows a block diagram of an overall communication system incorporating one embodiment of the present invention for estimating ink usage with a stand alone generic printer driver or a remote printer driver associated with a server. Namely, the user host communication system 200 of one embodiment of the present invention can include generic printer drivers 202, 204, 206, which are independent network environments. The generic printer drivers 202, 204, 206 can be linked to the internet 208, which can also link the users to suppliers 210, and the host 212. The host 212 is preferably a computer system which is linked to the server printer driver 214, and in turn to the server 216.

A consumable order assistance system could be provided for the computer environment and peripheral devices of FIG. 2. The system may include a PC, one or more computer peripheral devices, and a user interaction site. The PC has a messaging system as well as the peripheral device. The communication link signal couples the PC with a seller, reseller or other provider of a consumable for the computer peripheral device. The user interaction site is configured to receive notification from the computer peripheral device via the messaging system of a need to order a consumable. The user interaction site is provided within one of a single connection environment as an end user interface, an unmanaged network environment as a work group administrator interface, or a server based centralized network environment as a centralized system administrator interface.

A computer implemented self adjusting consumable order assistance system could be provided which implements a program in which consumable components of computer peripheral devices are replenished. Also, a method of providing order assistance could be provided. The method could include: providing a computer peripheral device, a PC having a communication link with a provider of a consumable, a messaging system extending between the computer peripheral device and the PC, and a user interaction site; determining an environment in which the computer peripheral device and the PC are provided by detecting the presence of a parallel cable or the presence of a network environment; for the case where the presence of a network environment is detected, further broadcasting a discovery protocol to detect the presence of a centralized order assistance solution; and abased on the determined environment, providing the user interaction site in the form of a user interface, web server, or centralized system administrator.

In turn, this has led to an ability to detect the need for consumables, as well as an ability order greater amounts of consumables, some of which are specific, to specific types of hard copy output engines, through internet sub-systems. One such method employs image forming devices to facilitate the ordering of imaging consumables.

Image forming devices may include an interface adapted to communicate with a communication medium external of the image forming device, imaging circuitry configured to use an imaging consumable to form hard images, a sensor to monitor the status of the imaging consumable, and processing circuitry coupled with the sensor and configured to generate a message indicating the status of the imaging consumable. This message could be communicated externally at a predetermined moment in time through the interface.

Such systems could control the formulation of one or a plurality of consumable order assist functions configured to assist replenishment of an imaging consumable. These systems have an ability to report the quantity of consumables used in the various scheduled jobs. The reports may include the amount and type of print media used and remaining in the system, the amount of ink/toner used and remaining in the system etc. In addition the user may be automatically alerted to the need for the replacement of consumables and be linked to suppliers related to the products in the system.

While these systems give an accurate estimate of the consumables used, and the consumables remaining in the system, they do not inform the user of the amount of imaging consumables used prior to the job commencing. In addition the user is unable to compare the requirements of producing images on one system with that of another or a plurality of other systems.

III. Details of the Operation:

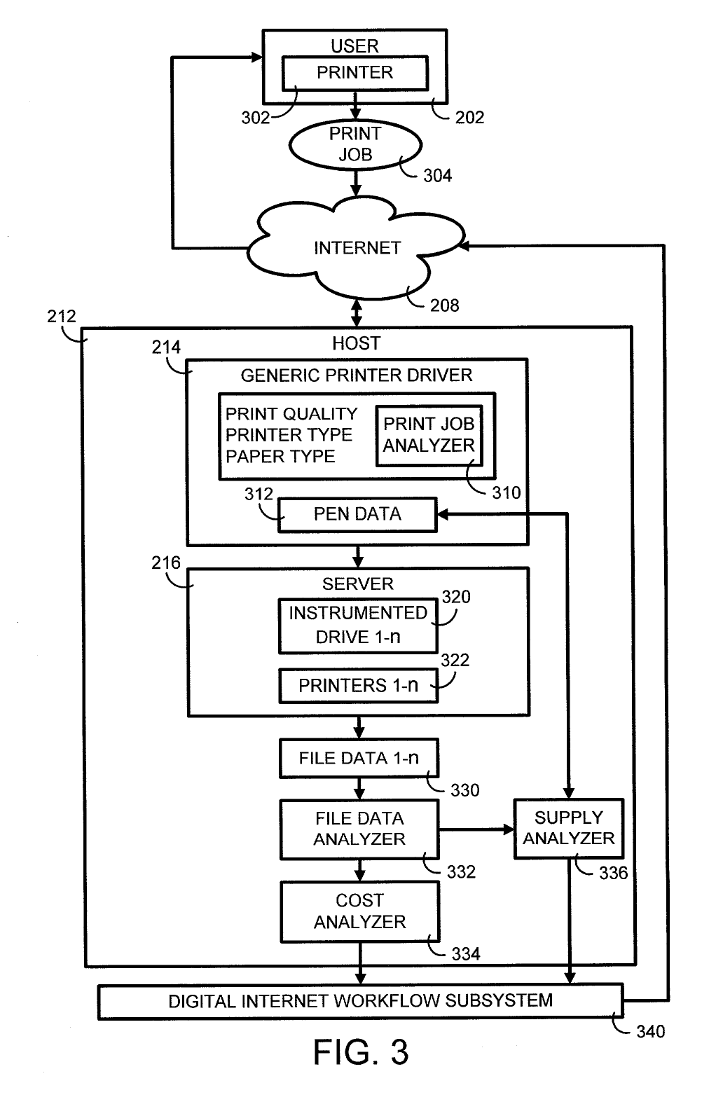

FIG. 3 shows for illustrative purposes only a flowchart depicting how the print job is sent to the host printer driver 214 or to the printer driver 202, 204, 206,of the stand alone system according to one embodiment of the present invention. As shown in FIG. 3, the independent network environment of the user 202, includes a peripheral device for producing print images designated for these purposes, but not limited to, a printer 302. The printer 302 contains print consumables for print a print job 304. Pre printing, the print job, which could be in the form of a data file or other data storage medium, could be analyzed at the stand alone printer driver 202, 204, 206, or forwarded via a communication link, which could be the Internet 208, to a host 212.

The printer driver 214 in the host 212 computer system, contains the print job analyzer 310 and the ink cartridge data 312 forwarded from the user. The print job analyzer 310, analyzes the print job 304 to determine the parameters of the print job 304 that impinge on ink usage. These parameters may include but would not be limited to, printhead temperature, print quality, pages to be printed, printer type, paper type, inks to be used etc. The printer driver 214 would include the relevant ink cartridge data 312, such as type of ink cartridge, inks, ink reservoirs etc., and would forward these data, along with the print job analyzer 310 data to the server 216.

The server 216 in one embodiment of the present invention incorporates the instrument driver 1-n, and the printer 1-n. Data from the printer driver 214 are linked to the printer 302 of the user and to the generic printer driver 202, as well as to options within the server 216. These options are various combinations of instrument driver and printer. Combinations could be by specific request of the user, or could be the result of a request by the user for a range of options. The server 216 produces the various compilations of data as specific files, file data 1-n, 330.

File data 330 are forwarded to the file data analyzer 332 which determines the amount of print image consumables for the print job 304. The amount of print image consumable is compared to the data from the ink cartridge data 312, in the supply analyzer 336. The amount of consumable to complete the print job 304 is referred to the user via the digital internet workflow subsystem 340 through the internet 208.

Simultaneously, the cost analyzer 334, receives information on print image consumables from the file data analyzer 332, and determines the cost to the user of the various print options computed by the server 216. These costs are referred to the user via the digital Internet workflow subsystem 340 and the Internet 208.

A number of benefits to the user are evident by the incorporation of this system. First, the user does not have to have instrument drivers or multiple peripheral image producing devices on the user network system saving money. Second, the user can access the best of a variety of choices from instrument driver 320 and printer 302 before proceeding with a print job 304. Also, the variety of choices can be processed simultaneously saving the user time. In addition, the user is apprised ahead of time of the cost of the print job 304, so that an alternative can be selected if desired. Next, the user is informed before printing, if there is sufficient image printing consumables to complete the submitted print job 304. Further, the user is linked by a communication system such as the internet 208, to a supplier 210 who may be an integral factor in a pro-active system to replace and upgrade print image consumables.

IV. Ink Usage Monitoring Alternative Embodiment

In an alternative embodiment, ink usage monitoring can be accomplished with the printer driver. For example, at the beginning of each print job, the printer driver can synchronize with the printer and query the printer for calibrated (adjusted for temperature) drop count information. The driver then can record the ink drop count information in a log file, which is later retrieved for ink usage analysis and other market research purposes. A printhead identification number can be similarly queried and recorded to ensure the drop count information is consistent, in other words, to account for situations such as mid-job printhead changes.

Also, the query can determine and track ink refills for warranty programs and can also void warranties if the printhead is tampered with or refilled. Further, ink usage data can also be used to provide other customer benefits, such as automatic low ink reminders and target advertisement/incentive programs. For example, the customer can be directed to certain World Wide Web site for ordering products or offering customers discounted ink cartridge purchase prices for customers with high ink usage.

The foregoing has described the principles, preferred embodiments and modes of operation of one embodiment of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

1. A method for estimating ink usage of a print job, comprising:
connecting a computer peripheral device to a host computer having predefined information relating to the peripheral device; and
offering pricing and estimation of ink and image consumables for completing the print job, before the print job is performed.

2. The method of claim 1, wherein the host computer is linked to a generic printer driver located on the host computer.

3. The method of claim 2, wherein the host computer is linked to a remote printer driver in a server system.

4. The method of claim 3, wherein the server supplies information pertaining to a number of instrumented drivers and printers to the host computer.

5. The method of claim 3, wherein the remote server is linked to the host computer via at least one of the Internet or a local intranet.

6. The method of claim 1, further comprising determining printing parameters for choosing a print option that best fits budgetary and printing requirements of the print job.

7. The method of claim 6, wherein the printing parameters includes at least one of print quantity, print quality, print type and paper type.

8. The method of claim 6, wherein the printing parameters are ascertained by a remote printer driver and forwarded to a server.

9. The method of claim 8, wherein the printing parameters are incorporated by the server in data files to be used by various combinations of instrumented drivers and printers located on the server and shared by other printers connected to the server.

10. A method for analyzing ink usage for a printer, comprising:
communicating a type of ink cartridge and ink reservoir system to a host computer as part of a print job submission;
estimating the ink to be used in a print job based on predefined printing requirements; and
determining the number of print swaths and pages the ink cartridge can complete based on ink available in the ink reservoir system.

11. The method of claim 10, further comprising relaying to the determined information to a user.

12. The method of claim 11, further comprising providing the user with a plurality of options, including allowing the print job to proceed, choosing an alternative printing system, and ordering ink consumables for the printer.

13. The method of claim 12, further comprising offering the user upgrade options, including ordering a generic stand alone printer driver and a go server printer driver.

14. The method of claim 11, further comprising providing the user with a hyperlink via the Internet to a supplier of the printer for automatic ordering of the ink consumables.

15. An ink usage monitoring system for estimating ink usage of a print job, comprising:
a computer peripheral device for performing the print job; and
a host computer connected to the computer peripheral device and having predefined information relating to the peripheral device, wherein the host computer has pricing and estimation of ink and image consumables for completing the print job, before the print job is performed.

16. The ink usage monitoring system of claim 15, further comprising a remote printer driver located on a server that is connected to the host computer.

17. The ink usage monitoring system of claim 16, wherein the server supplies information pertaining to a number of instrumented drivers and printers to the host computer.

18. The ink usage monitoring system of claim 17, wherein the remote printer driver includes at least one of firmware and software that determines printing parameters for choosing a print option that best fits budgetary and printing requirements of the print job.

19. The ink usage monitoring system of claim 18, wherein the printing parameters includes at least one of print quantity, print quality, print type and paper type.

20. The ink usage monitoring system of claim 18, wherein the printing parameters are ascertained by the remote printer driver and forwarded to the server that is connected to the host computer.

21. An ink usage monitoring system for estimating ink usage of a print job, comprising:
means for connecting a computer peripheral device to a host computer having predefined information relating to the peripheral device; and
means for offering pricing and estimation of ink and image consumables for completing the print job, before the print job is performed.

22. The ink usage monitoring system of claim 21, wherein the host computer is linked to a generic printer driver located on the host computer.

23. The ink usage monitoring system of claim 22, wherein the host computer is linked to a remote printer driver in a server system.

24. The ink usage monitoring system of claim 23, wherein the server supplies information pertaining to a number of instrumented drivers and printers to the host computer.

25. The ink usage monitoring system of claim 23, wherein the remote server is linked to the host computer via at least one of the Internet or a local intranet.

26. The ink usage monitoring system of claim 21, further comprising means for determining printing parameters for choosing a print option that best fits budgetary and printing requirements of the print job.
